(19) United States
(12) Patent Application Publication
(10) Pub. No.: US 2008/0272508 A1
(43) Pub. Date: Nov. 6, 2008

(54) MANUFACTURE OF SPHERICAL PARTICLES OUT OF A PLASTIC MELT

(75) Inventors: Brent Allen CULBERT, Wil (CH); Andreas Christel, Zuzwil (CH); Erhard Krumpholz, Niederuzwil (CH); Theodor Juergens, Casstrop-Rauxel (DE); Rudolf Geier, Essen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BUEHLER AG, Uzwil (CH)

(21) Appl. No.: 11/876,325

(22) Filed: Oct. 22, 2007

Related U.S. Application Data
(63) Continuation of application No. 10/496,786, now abandoned.

(30) Foreign Application Priority Data
Dec. 11, 2001 (DE) 101 60 707
Feb. 6, 2002 (DE) 102 04 954

(51) Int. Cl. B29B 9/00

(52) U.S. Cl. 264/8; 264/13; 264/14; 264/12; 425/6; 425/10; 425/7

(57) ABSTRACT

The invention relates to a method and a device for producing spherical particles from a melted mass of plastic. According to the invention, said melted mass is transformed into droplets by means of a droplet-forming nozzle (10); after falling a certain distance, the droplets are crystallised at least on the surface thereof; the droplets are then supplied to a crystallisation stage in which they are fully crystallised; and are then supplied to an postcondensation stage wherein solid phase polycondensation takes place. In order to ensure surface crystallisation without the risk of adhesion both among the drops and to parts of the device, the drops fall in a crystallisation stage (45) having a cloth element or a sheet metal element comprising openings or a fluidised bed chamber through which gas flows in order to swirl the drops.

The invention relates to a method for manufacturing spherical particles out of a plastic melt, in particular a prepolymer- or polymer melt of a polycondensate, e.g., PET, PBT, PEN, PA or PC from polyfunctional carbonic acids and alcohols, wherein the melt is dripped into drops by means of an dripping nozzle, and the drops are solidified into particles after falling at least part of a drop distance.

The invention also refers to a system for manufacturing spherical particles out of plastic, in particular out of prepolymer or polymer melt of a polycondensate, e.g., PET, PBT, PEN, PA or PC, from polyfunctional carbonic acids and alcohols, comprising an nozzle array that drips the plastic melt into drops, and a downstream drop distance in a drop tower.

It is known for manufacturing PET granules to route a precondensate to a reactor placed under a vacuum after the esterification and re-esterification and prepolycondensation of ethylene glycol or butane diol in a PBT process and terephthalic acid. The objective here is to increase the viscosity of the largely fluid and short-chained polymer on the one hand, and return released ethylene glycol and butane diol to esterification or re-esterification on the other. After treated in the reactor, the polycondensate is cooled in water and cut into granules in order to obtain cylindrical pellets that are largely amorphous. However, the disadvantage here is that the ends have crusts that break off, and hence can cause dust to form. Another disadvantage to the known method is that the pellets are present in a largely amorphous state after granulated, which necessitates partial crystallization in a downstream, separate treatment step. The high system and energy outlay is also disruptive, since special treatment stages such as depressurized reactor stage and partial crystallization are required.

In order to avoid these disadvantages, DE 198 49 485 A1 proposes that molten precondensate be routed to a drop tower with a distributor drop nozzle, wherein the precondensate exiting the distributor drop nozzle is countercurrently pressurized with an inert gas like nitrogen in the drop tower. This reduces the falling rate while simultaneously accelerating a crystallization of the drops. The particles exiting the bottom of the drop tower can then be passed as dried and partially crystallized pellets to postcondensation or SSP.

DE 100 19 508 A1 describes a corresponding method. The drops are here pressurized countercurrently to air or inert gas like nitrogen.

In order to cool liquid PET prepolymer from about 280° C. to 160° C., and hence reach the favorable crystallization rate lying between 150° C. and 170° C., more than 220 KJ/Kg of heat must be removed from a kilogram of PET spheres. Since the commonly used gases like air or nitrogen have only a slight thermal capacity (about 1.05 KJ/Kg), relatively high mass and volumetric flows of the gas are required to cool the fluid, hot polymer droplets, despite the use of large temperature differences to absorb the heat. Another disadvantage is that heat transfer from a gas to a solid is relatively poor, so that relatively high drop distances result, and a defined cooling or drop temperature is difficult to set after a specific drop height.

A gas, e.g., one heated from 50° C. to 200° C., can absorb a total of about 160 KJ/Kg gas. Therefore, a gas stream of about 1.4 Kg gas/Kg PET or 1,400 m³ gas/1,000 Kg PET is required. For example, given a drip ate of 1 t PET per hour in a drop tower with a diameter of 1.2 m, this means that a gas stream of at least 1,400 m³/h is required.

Another disadvantage to the large quantities of gas is that turbulences and at least disruptive cross flows come about, thereby giving rise to the danger that the highly adhesive spheres, which can have a diameter on the order of 0.8 mm, will contact and become stuck to the walls of the drop tube, or stick to each other and become deformed in such a way that the final geometry does not exhibit the desired spherical shape.

In order to manufacture plastic spheres with a uniform geometry, DE 43 38 212 C2 proposes that plastic with a molten consistency be dripped by initiating oscillation in a nozzle arrangement, wherein the drops generated in this way are cooled in a liquid.

The object of this invention is to further develop a method and device of the kind mentioned at the outset in such a way that the plastic melt mentioned at the outset, in particular molten prepolymer or polymer of a condensate, can be dripped at a desired high throughput without resulting in the danger of the dripped particles deforming or sticking, or the dripped particles sticking to each other and/or particles adhering to the boundaries of the drop distance itself. In another aspect of the invention, the overall time within which the dripped particles are postcondensed to a sufficient extent is to be significantly reduced in comparison to known methods.

In terms of the method, the object is achieved among other things by virtue of the fact that, at the end of the drop distance, the particles get into a receiving area where at least a portion of the particles are swirled in such a way as to produce turbulences for moving the particles toward the middle of the area and/or area outlet opening.

The term “swirled” is intended to refer to both a primarily stochastic (random) movement of particles in terms of fluidizing, and to a primarily collective (ordered) movement of particles, wherein this naturally also involves combined movement states of the “particle swarm” with a stochastic share and a collective share of the movement pattern.

The term “solidified” is intended in the following description to refer essentially to dimensionally stable amorphous and/or crystalline particles.

The particles can also be swirled in the receiving area by blowing in a gas through numerous gassing holes.

In a special embodiment of the method according to the invention, the particles in the receiving area are swirled by means of a cloth-like element interspersed with gas and made to oscillate and/or routed to an area with an intrinsically stiff element at the end of the drop distance that is pressurized with gas in such a way as to produce turbulences for moving the drops toward the middle of the area and/or area outlet opening.

The particles are preferably swirled in such a way that the swirled particles form a fluidized bed, wherein the particles are preferably routed to the fluidized bed via a fluidized bed inlet area on the drop distance, and moved therein to a fluidized bed outlet area, in which the area outlet opening is located. The particles are preferably deflected toward the fluidized bed inlet area at the end of the drop distance. These measures ensure that all particles have roughly the same retention time, and in particular a minimum retention time determined by the geometry of the fluidized bed.

In a particularly advantageous embodiment of the method according to the invention, the particles in the drop distance are pressurized with a fluid, in particular a liquid. The fluid is preferably used to intensify the cooling of particles falling over the drop distance. It is particularly advantageous to use a liquid to pressurize the particles, since a great deal of heat can be removed from the hot particles via the evaporation of liquid in this way.

In terms of the method, the object can also be solved in the method mentioned at the outset just by exposing the particles in the drop distance to a liquid.

The evaporation point of the mentioned liquid best lies below the melting point of the particles. This ensures that a great deal of heat will be removed from the solidified drops or particles via the heat required for the phase transition of the liquid.

It is particularly advantageous to use water and/or ethylene glycol as the liquid, wherein in particular the liquid is metered in such a way that the particles are essentially no longer wetted upon reaching the receiving area.

The liquid is preferably atomized in the form of fine droplets, so that the drops in the drop distance dripped into droplets with the dripping nozzle are pressurized with a spray mist. It has proven to be particularly advantageous to set the spray mist in such a way that its drop size corresponds to about ⅓ to 1/20 of the drop size of the dripped melt.

The liquid can also be supplied in a carrier gas, which preferably has at least one of the gases air, nitrogen, carbon dioxide, argon, water vapor or ethylene glycol vapor.

In the method according to the invention, the drops are best initially crystallized after falling through at least a portion of the drop distance. This precludes the danger of sticking or adhering droplets described at the outset.

The drops are preferably only cooled to a point at which their temperature remains over the glass transition temperature T_{g} of the plastic. This keeps the energy demand low when reheating (SSP) the particles.

Another advantageous embodiment of the method according to the invention involves recovering the thermal energy of the process gases, such as air, nitrogen, carbon dioxide, argon, water vapor or ethylene glycol vapor, present in the drop distance.

In an expedient further development of the method according to the invention, the spherical or sphere-like particles are routed to a crystallization stage after leaving the receiving area. In this stage, the drops at least initially crystallized in the drop distance are further or completely crystallized.

In another advantageous further development of the method according to the invention, the spherical particles are routed to a post-condensation stage for solid phase polycondensation after passing through one or more crystallization stages (drop distance, crystallization stage). This makes it possible to obtain spherical particles that are particularly advantageous for further processing (shaping via injection molding, stretch blow molding, etc) articles of daily use due to their material properties and geometric shape.

The receiving area according to the invention is preferably pressurized with pulsed gas, such as air.

It is also advantageous for the method according to the invention for the receiving area to be funnel-shaped, and have gas-permeated openings on the drip side that run in such a way as to move or swirl the drops tangentially along the inner surface of the funnel-shaped area.

The receiving area can be pressurized using a gas with a sinusoidal pressure characteristic.

It has proven to be particularly advantageous for the pulsed gas to pressurize the receiving area at a frequency f of preferably 1 Hz≦f≦30 Hz, in particular 1 Hz≦f≦10 Hz.

It is here advantageous for the gas to permeate the receiving area at a maximum velocity v of v≦4 m/sec, in particular v≦3 m/sec, preferably v≦1 m/sec.

It is also advantageous for the gas to pressurize the receiving area with a pressure p of 0 mbar≦p≦200 mbar, in particular 0 mbar≦p≦150 mbar over atmospheric pressure.

In particular, it is provided that the receiving area use openings with a mesh size of d≦80%, in particular d≦30% of the average particle diameter.

In another advantageous further development of the method according to the invention, a portion of the particles crystallized into spheres or at least initially crystallized is removed from the crystallization device and returned to the drops falling through the drop distance above the receiving area. About 10 to 50% of the spheres removed from the crystallization device are preferably returned to the receiving area.

A chain lengthener can be added to the melt immediately prior to dripping to accelerate postcondensation, wherein the share of chain lengthener in the melt to be dripped measures <0.5% w/w.

The chain lengthener is preferably added to the melt in an amount in which it becomes active after less than 10 min, in particular within a period of between 1 min and 10 min. Possible chain lengtheners include a chain lengthener based on polyol, dianhydride of a tetracarbonic acid, pentaerythrite or oxazolines.

The drops are best exposed over at least part of the drop distance to a countercurrent or cocurrent, which is preferably laminar, wherein the countercurrent is withdrawn at a velocity of less than 0.2 m/sec, preferably less than 0.1 m/sec, and the cocurrent at a velocity of less than 1 m/sec, preferably less than 0.5 m/sec.

In another advantageous configuration of the invention, the gas permeating the receiving area flows through a first cycle, wherein a portion of the gas is routed to a cleaning station, in which the gas is cleaned and cooled, after which it is returned to the cycle once again. The gas is here preferably guided in the cleaning station countercurrently or cocurrently to a glycol cycle.

In a first embodiment of the method according to the invention, the cloth-like element comprising the receiving preferably forms a funnel through which the drops or particles are routed to the crystallization device, and then to the postcondensation stage. The cloth-like element that causes the swirling performs the function of a pre-crystallization stage.

The funnel-shaped, intrinsically stiff element, e.g., sheet, that forms the receiving area in a second embodiment (“Conidurblech”®) works with specially arranged openings. This sheet has specially arranged openings with a special geometry, which use the gas flowing through to generate turbulences directly behind the passage, which drive the drops and particles toward the middle of the funnel. Just as with the cloth-like element, the pulsating gas stream prevents the drops and particles from sticking together, and the particles from sticking to devices or boundaries of the drop distance. The funnel-shaped, intrinsically stiff element hence also performs the function of a pre-crystallization stage.

The fluidized bed forming the receiving area in a third embodiment makes it possible to keep the particles accumulated or trapped after traversing the drop distance in a fluidized state, in which a mutual adhesion or sticking of the particles to boundaries is virtually precluded. In addition, the fluidized state of the particles in the fluidized bed provides for a lot of leeway during the geometric design of the receiving area.

The instruction according to the invention basically no longer makes it necessary to pressurize the drops and particles with high gas streams during their initial crystallization; rather, it is enough to swirl the particles, e.g., via the cloth-like element, to achieve a hardening on the periphery that enables subsequent crystallization or postcondensation to take place without the particles sticking together or becoming deformed to an extent that the final drops solidified into particles no longer exhibit the desired spherical shape. The instruction according to the invention makes it possible to manufacture particles with a diameter of 0.1-3 mm, in particular of 0.4-1.6 mm.

In particular, the invention provides that the fluidized bed, the pulsating cloth or the funnel-shaped, intrinsically stiff element, e.g., sheet element, with specially arranged openings, on whose side facing the product the pulsating gas generates turbulences and flows, swirl the drops in such a way as to prevent the drops from sticking together and to the cloth or element itself.

Because the drops are centrifuged away on impact by the pulsating, cloth-like element, which in particular is one comprised of polytetrafluoroethylene (Teflon) with openings, no adhesion to the cloth-like element takes place on the one hand, and particles adhere to each other for an exceedingly short time owing to the transmitted pulses, thereby precluding any agglutination.

During the use of the funnel-shaped sheet, the turbulences that form right in back of the openings ensure that there will be no adhesion to the sheet or an agglutination of drops.

In particular, it is provided that the cloth-like element has openings with a mesh width d of ≦0.2 mm, in particular d≦0.1 mm.

In addition, the gas permeating the cloth-like element should have a temperature of between 80° C. and 170° C. in this area.

Corresponding dimensions and parameters also apply to the funnel-shaped sheet (“Conidurblech”®) and the gas flowing through it.

The gas can be passed through a cycle in which a heat exchanger is arranged. The gas, e.g., air, only needs to be heated by this heat exchanger at the beginning of the dripping process. The temperature is subsequently adjusted via the thermal transfer from the drops on the one hand, and by virtue of the fact that a portion of the gas carried in the cycle is removed and routed to a cleaning station that encompasses a glycol cycle on the other. The gas is simultaneously cooled in the process, and then returned to the cycle. Purifying the gas simultaneously removes oligomers.

Another configuration of the invention to be highlighted provides that the crystallization device placed downstream from the cloth-like element or funnel-shaped sheet element or the fluidized bed or equivalent element is designed in such a way that a portion of the drops crystallized into drops or initially crystallized are removed and returned to the drop distance above the cloth-like element. In this case, about 10-50% of the spheres removed from the crystallization device should be returned.

The spheres are routed from the crystallization device to the post-polycondensation stage via a transfer channel, wherein the spheres are set to an ambient pressure p of p≦2, in particular p≦0.5 mbar, in the transfer channel. The transfer channel itself can be sealed at the inlet and outlet by a shut-off element, which is designed as an iris diaphragm or other suitable sealing element, for example, to prevent destruction of the spheres. A corresponding transfer channel should basically be placed downstream from the post-polycondensation stage to adjust the spheres to an atmospheric pressure without also giving rise to the danger of oxygen penetrating into the post-polycondensation stage. Post-condensation under an inert gas flow can also ensue in place of this “vacuum SSP”. Both continuous and batch processing are possible.

In the post-polycondensation stage itself, the spheres are relayed to a post-condensation stage performed under a vacuum, preferably in the form of a slowly rotating shaft, wherein a retention time in one further development according to the invention can be held to less than 15 hours, in particular to between 8 and 12 hours, by adding a chain lengthener or chain extender known form plastic extrusion to the melt shortly before it is dripped. However, the chain lengthener, which binds hydroxyl groups in the polymer and very rapidly increases the molecular weight, is only added shortly before dripping the melt, so that the melt viscosity does not negatively affect drop formation. At the same time, the drop distance and retention time in the crystallization stage are harmonized in such a way that the chain lengthener can exert its influence essentially in the post-polycondensation stage. The chain lengthener should therefore be selected and added to the melt in quantities where chain lengthener becomes active 1 to 10 minutes after added. Chemical families for corresponding chain lengtheners include pentaerythrite or polyols. Preferred chain lengtheners include oxazolines like soybean oxazoline, castor oxazoline or bis-oxazoline. In this regard, reference is also made to the publication Kunstoffe 83 (1993, 8, pp. 885-888) and corporate publication “Henkel, Plastics and Coating Technology, PM Europe/Overseas, May 1994, Oxazolines for the reactive extrusion”.

In particular, the share of chain lengthener in the melt should measure less than 0.5% w/w, preferably less than 0.2% w/w. In addition, the melt should be adjusted in such a way that its intrinsic viscosity (i.V.) measures i.V.≦0.4 dl/g, in particular 0.1 dl/g≦i.V.≦0.35 dl/g, in the dripping process.

The advantage to spraying liquid, in particular water, into the drop distance is that it permits a desired cooling of the dripped melt without requiring too great a volumetric flow, which might otherwise swirl the drops, hence causing these to adhere to each other or stick to the walls.

In this case, the spray mist, e.g., water spray mist, should be metered in such a way that the gas or droplet temperature as measured at distances of several meters under the spray mist sets roughly the optimal crystallization temperature.

A liquid medium, e.g., water, has an evaporation enthalpy of about 2,400 KJ/kg, and increasing the vapor temperature from about 100° C. to 200° C. requires an additional 200 KJ/kg. Therefore, only 80 kg of water/t of PET is needed to cool 1 t of PET from 280° C. to 160° C. According to the invention, the corresponding liquid is introduced in direct proximity to the drop distance as very small spray water droplets annularly sprayed around the drops falling in the drop distance. The water droplets are hence subjected to direct evaporation, so that higher quantities of heat can be extracted from the drops as a result.

In particular, it is possible to expose the drops to a relatively low-speed flow, so that a laminar flow can be generated on the one hand, while not impeding the falling motion of the droplets on the other. In addition, the advantage to water vapor that arises during evaporation is that it renders the droplets inert, thereby precluding in particular undesired deposits in the area of the dripping nozzle.

In terms of the device, the problem described at the outset is resolved by an arrangement for manufacturing spherical particles out of plastic of the aforementioned kind, characterized in particular by the fact that the drop distance passes over into a receiving area in which at least some of the particles can be swirled in such a way as go generate turbulences to move the particles toward the middle of the area and/or outlet hole of the area.

Another arrangement for manufacturing spherical particles out of plastic of the aforementioned kind is characterized by the fact that a device for exposing the particles to a liquid is allocated to the drop tower.

The receiving area situated under the drop distance or in the lower area of the drop tower is preferably designed as a funnel.

At least part of the receiving area can preferably be vibrated by vibration means.

The receiving areas can preferably be exposed to a gas via numerous gassing holes.

In a special embodiment of the arrangement according to the invention, the drop distance passes over into a funnel-shaped receiver peripherally bordered by a pulsating, cloth-like element and/or intrinsically stiff element with holes.

The receiving area is preferably structured in such a way as to have a defined inlet area and defined outlet area. The end of the drop distance or the lower end of the drop tower can have deflection means that can guide the particles to the inlet area. As an alternative, the melt outlet holes of the nozzle array can be arranged in an area of the nozzle array that is situated vertically above the inlet area and has essentially the same layout as the inlet area. In this conjunction, it is particularly advantageous if at least some of the melt outlet holes of the nozzle array are angled relative to the vertical. These measures ensure that the particles can be passed to the receiving area in a defined inlet area.

In a particularly advantageous embodiment of the arrangement according to the invention, the drop tower incorporates atomizing means that can be used to introduce an atomized liquid into the drop distance.

There can also be means for recovering thermal energy, which can be used to recover the process heat contained in the process gases present in the drop tower.

In a further configuration of the arrangement according to the invention, a crystallization stage follows the receiving area.

In addition, the one or more crystallization stages can have a downstream post-condensation stage for solid-state polycondensation (SSP), for which a vacuum-SSP or SSP under inert gas is set up.

The receiving area can preferably be exposed to a pulsating gas, such as air. This makes it possible to swirl or fluidize the particles that get into the receiving area in a particularly effective manner.

The receiving area according to the invention can be a cloth-like element that is secured to a funnel, e.g., a metal or special steel funnel, and can be spaced apart relative to its inner surface in such a way that a line incorporating a shut-off element that releases or blocks said line empties into the gap between the cloth-like element and funnel. However, the cloth-like element in the receiving area can also be replaced by an intrinsically stiff element, which is enveloped at a distance by a funnel element in such a way that a line incorporating a shut-off element that releases or blocks said line empties into the gap between the intrinsically stiff element and the funnel element, similarly to as described in the previous sentence.

Instead of having a cloth-like element or intrinsically stiff element, the receiving area can also be a fluid-bed chamber preferably connected by numerous gassing holes with a gas inlet chamber, into which empties a line incorporating a shut-off element that releases of blocks said line.

The arrangement according to the invention is preferably laid out in such a way that the gas can be made to pulsate at a frequency f when supplied to the gap, wherein the frequency f in particular measures 1 Hz≦f≦30 Hz, preferably 1 Hz≦f≦10 Hz.

It is particularly expedient to design the holes in the receiving area in such a way that the gas penetrating them flows along the inner surface of the receiving area, in particular in a turbulent manner.

It is also advantageous to design the holes in such a way that the gas passing through them flows tangentially to the inner surface of the intrinsically stiff element.

The gas can preferably be supplied to the gap of the arrangement with a sinusoidal pressure progression.

It is particularly expedient for the receiving area to be anti-adhesive, and to consist in particular of polytetrafluoroethylene.

The receiving area preferably has holes with a mesh size d of d≦0.6 mm, in particular d≦0.3 mm. This mesh size setting is particularly well suited for particles having a sphere diameter of about 0.8 to 1.2 mm.

One particularly advantageous configuration of the arrangement according to the invention has a first cycle through which the gas penetrating the receiving area flows, and from which a branch running along the drop distance exits the drop distance at distance A, wherein a ring element that emits a spray mist, envelops the drop distance and is equipped with spray nozzles is located above distance A. The ring element enables a uniform spraying of particles passing through the drop distance with a cooling fluid, which wets the particles and evaporates to cool the particles.

The ring element with spray nozzles is preferably situated in a second cycle, which itself is routed out of the drop distance below the nozzle array that drips the melt.

Some of the gas in the first cycle can preferably be relayed to a cleaning station with a glycol circulation. The glycol carried and heated in the cleaning cycle can hence itself be used for esterification.

The crystallization device preferably has an inlet hole, which is simultaneously the outlet hole of the funnel-shaped receiving area.

It is also advantageous to place the crystallization device in another cycle, through which some of the spheres crystallized in the crystallization device above the funnel or intrinsically stiff element can be returned to the drop distance.

If present, the post-condensation stage preferably has an upstream and/or downstream transfer channel, which can be sealed at the inlet and/or outlet by a shut-off element preferably designed as an iris diaphragm.

It makes sense in the arrangement according to the invention for the nozzle array designed in particular as a vibratable nozzle plate to be connected to a line that supplies the melt, in which another line connected with a container for a plastic chain lengthener empties immediately before the nozzle element or into the nozzle element itself.

The cloth-like element or intrinsically stiff element and the metal sheet itself can be secured to a funnel, e.g., a metal or special steel funnel, and extend along its inner surface, wherein a line through which the gas can be supplied like air empties between the cloth-like element or the intrinsically stiff element, e.g., metal sheet, and the funnel. The line itself incorporates a shut-off element, e.g., a rotating disk, that releases or blocks the line, via which the pulsating gas can be supplied to the gap at a desired frequency v, wherein the frequency f measures in particular 1 Hz≦f≦30 Hz, preferably 1 Hz≦f≦10 Hz. Regardless of the above, the pressure progression in the gas should be sinusoidal.

The cloth-like element in particular involves one made out of polytetrafluoroethylene (Teflon), which has openings with a mesh size d of preferably d≦0.2 mm, in particular d≦0.1 mm.

The funnel-shaped, intrinsically stiff element, e.g., metal sheet, or the fluid-bed chamber involves an element having mesh sizes similar to the cloth-like element. However, the openings or holes are arranged in such a way that the pulsating gas is turbulent, and preferably moves tangentially along the inner surface and toward the preferably funnel-shaped orifice.

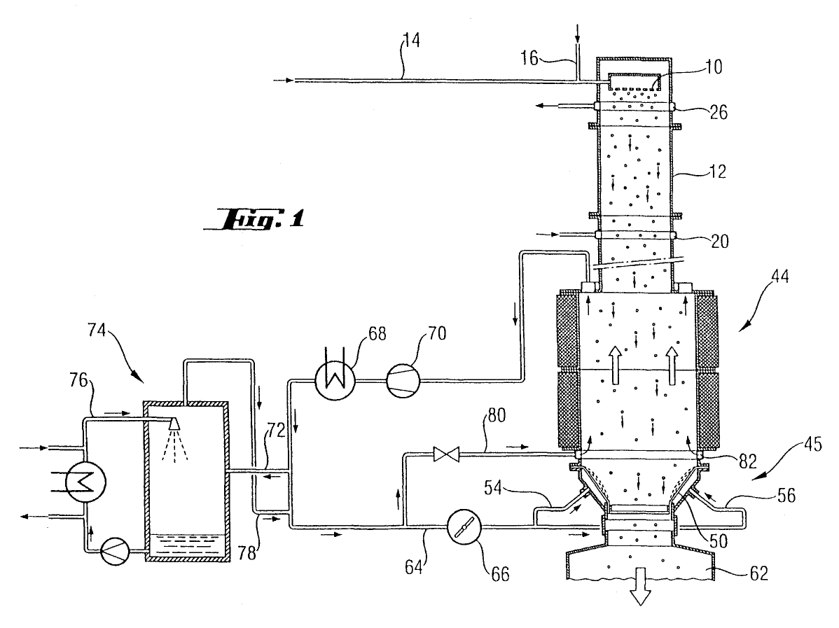

The gas passing through the fluid-bed chamber or cloth-like element or intrinsically stiff element flows in a first cycle, from which a branch running along the drop distance exits the drop distance at distance A (see FIG. 1).

A ring element that emits spray mist and envelops the drop distance is situated above distance A. This ensures a fine distribution of liquid droplets toward the falling drops to extract a sufficient amount of heat. The spray mist itself is incorporated in the section of a second cycle, which for its part is led away from the drop distance below the dripping nozzle that drips the melt.

Some of the gas in the first cycle is relayed to a cleaning station with a glycol circulation to clean the gas on the one hand and cool it on the other. As a result, the temperature in the cycle is set in such a way that the gas has a temperature of between 80° C. and 170° C. in the receiving area of the funnel.

The crystallization device has an inlet hole corresponding to the cross sectional hole of the funnel. In addition, the crystallization device is arranged in a third cycle, through which a portion of the spheres crystallized in the crystallization device can be returned to the drop distance above the funnel. These measures ensure that the drops relayed to post-polycondensation are crystallized to an extent that precludes agglutination.

The post-polycondensation or post-condensation device has an upstream and/or downstream transfer channel that can be sealed at the inlet and/or outlet by a shut-off element, preferably designed as an iris diaphragm or cell edge transfer channel, or another similarly acting or adequate shut-off element.

Arranging the transfer channels in this way ensures that oxygen can no longer penetrate in the post-condensation device. The use of shut-off elements designed as an iris diaphragm or similarly acting elements precludes the destruction of spheres to be supplied or carried away.

In an independent proposed solution of the invention, the nozzle array designed in particular as an oscillatable nozzle plate with a line supplying the melt, in which another line connected with a container for a plastic chain lengthener empties immediately before the nozzle or in the nozzle itself.

Additional details, advantages and features of the invention are disclosed not just in the claims and features to be derived from them, either individually and/or in combination, but can also be gleaned from the following description of the drawing.

Shown on:

FIG. 1 is a basic representation of a section of an arrangement for manufacturing spherical particles out of a polymer or prepolymer,

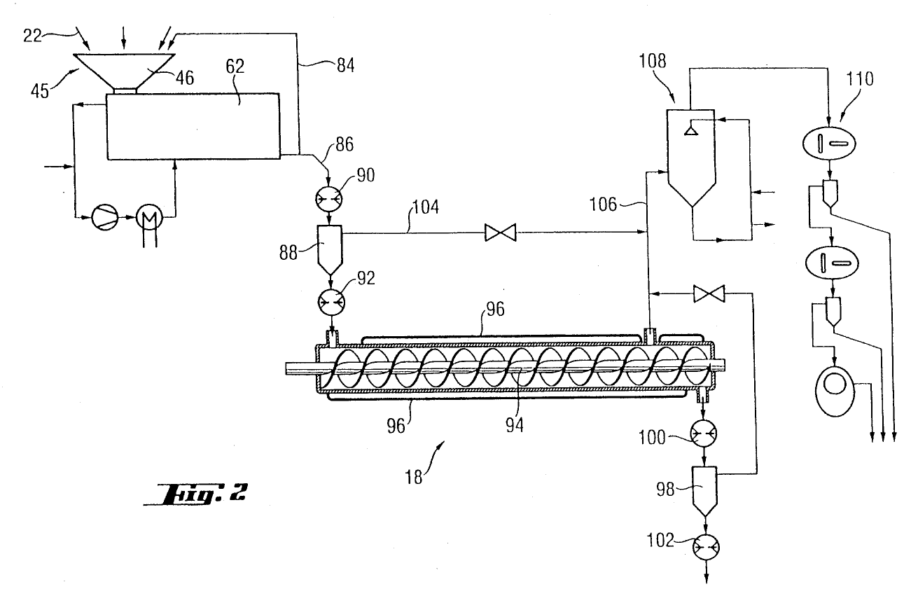

FIG. 2 is a basic representation of another section of an arrangement for crystallizing and post-polycondensing spherical particles,

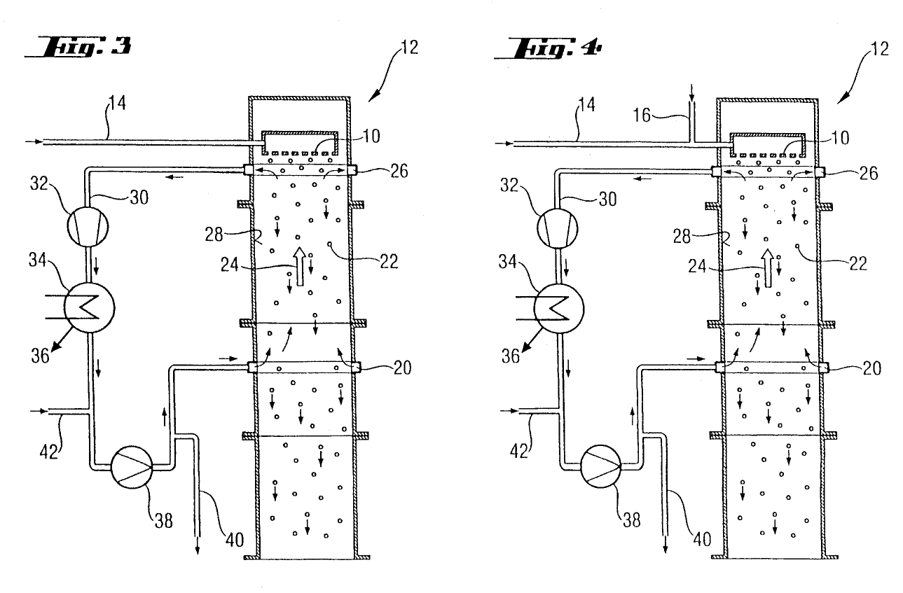

FIG. 3 is a first embodiment of a drop tower of the arrangement according to FIG. 1, basic representation,

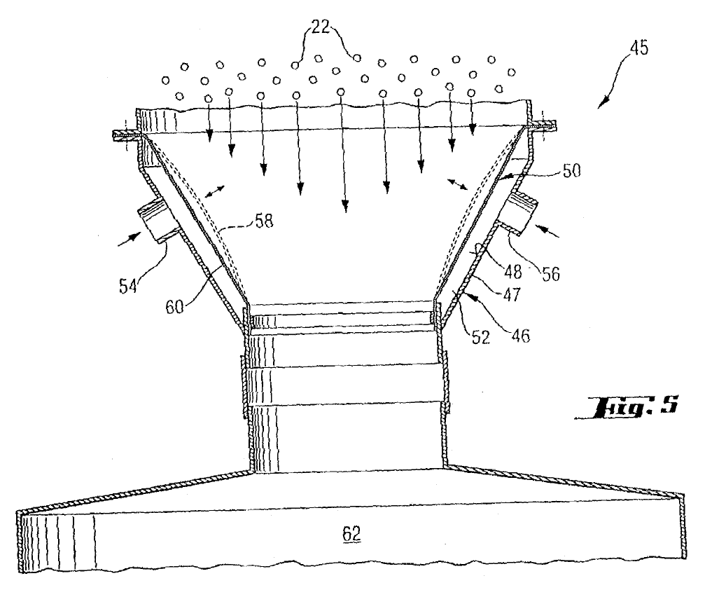

FIG. 4 is a second embodiment of a drop tower of the arrangement according to FIG. 1, basic representation, and

FIG. 5 is a basic representation of a funnel.

In order to fabricate spherical particles out of a polymer or prepolymer, in particular out of polyfunctional carbonic acids and alcohols, in particular to fabricate spherical PET (polyethylene terephthalate) pellets, a polyester precondensate with a product temperature of about 260° C. to 280° C. and an intrinsic viscosity IV of 0.10 to 0.35 dl/g is passed from a paste preparation stage (not shown), an esterification stage for terephthalic acid and ethylene glycol and a subsequent pre-polycondensation stage subjected to a vacuum via a heat exchanger and a filter to a nozzle plate 10, which is used to drip the well filtrated pre-condensate. When manufacturing PET pellets, the polyester condensate has a product temperature of between 220° C. and 260° C. and an intrinsic viscosity of between 0.1 and 0.5 dl/g.

The nozzle plate 10 can be made to vibrationally oscillate, and in particular has outlet holes arranged on concentric circles. In this regard, however, reference is made to known devices. The oscillator can be an electromagnetic oscillator, and is based on a load-bearing structure to impart oscillations to the nozzle plate. The frequencies with which the nozzle plate 10 is made to oscillate can range from 200 Hz to 2000 Hz. The diameter of holes in the nozzle plate 10 should lie between 0.2 mm and 0.8 mm. In addition, the polyester pre-condensate should be relayed to the nozzle plate 10 with an excess pressure of 0.2 bar to 1 bar, for example. The nozzle plate 10 is also uniformly heated, wherein in particular a temperature ranging between 250° C. and 290° C. is to be selected during the manufacture of PET pellets, and between 220° C. and 270° C. during the manufacture of PBT pellets.

In the exemplary embodiment, the nozzle plate 10 is situated in the top area of a drop tower 12, within which the melted prepolymers dripped by means of the nozzle plate 10 are uniformly dripped into equally large and uniformly shaped particles. In this case, the length of the drop tower can range from 10 to 15 m, for example, or even below that level, if needed. The drop tower 12 is magnified on FIGS. 3 and 4. The structure of the drop tower is here identical. The embodiments on FIGS. 3 and 4 differ in that another line 16 through which a chain lengthener (chain extender) is supplied to the melted prepolymer in a quantity of about 0.5% w/w or less empties in the line 14 supplying the precondensate to the nozzle plate 10 on FIG. 4. The chain lengthener is used to bind hydroxyl groups of the prepolymer given a simultaneous jump in molecular weight. Corresponding chain lengtheners come from chemical families like polyol or pentaerythrite, for example. Oxazolines merit special mention.

The corresponding chain lengtheners supplied via the line 16 are relayed to the melted prepolymer at one location where the intrinsic viscosity remains unchanged while dripping, which otherwise might give rise to disadvantages in the dripping process itself. At the same time, the chain lengthener is selected or added in a quantity that it essentially begins to exert its effect only in a post-condensation stage or post-polycondensation stage 18 to be described below.

Spaced apart from the nozzle plate 10 or similarly acting element, the drop tower 12 has an annular nozzle array 20, which comprises numerous nozzles to spray liquid particles into the drop tower 12, wherein in particular water is involved. In this case, the liquid is sprayed to an extent where the spray particles have diameters corresponding to ⅓ to 1/20 the size of the polymer drops 22.

The latter preferably measure 0.8 mm, while the liquid drops should measure at most 0.2 mm.

The spray mist itself is sprayed in countercurrently (arrow 24) to the falling direction of the drops 22, wherein the water vapor generated through interaction with the particles 22 is preferably withdrawn at a rate of ≦0.2 m/sec, in particular about 0.1 m/sec, in the top area of the drop tower 12 immediately below the nozzle plate via an annularly arranged gas suction device 26. The low velocity of the spray mist or water vapor flowing against the drops 22 precludes turbulences, thereby preventing the drops 22 from swirling, and hence stocking together or adhering to the inner wall 28 of the drop tower 12.

A cycle 30 comprising a fan 32 and vapor condenser 34 is provided for generating the spray mist. Non-condensable gases are discharged from it via a connecting piece 36.

The job of the vapor condenser 36 is to liquefy the vapor flowing in the cycle 30. The liquid is then relayed to the annular arrangement 20 by means of a pump 38. Since the temperature is at a high level, the heat from the vapor condenser 34 can be used to heat other system sections. To prevent undesired enrichment with oligomers, some of the water is continuously exchanged, i.e., a portion is discharged via a line 40 and replaced by a new portion via a line 42. This hot exchange water enriched with some oligomers and glycol can be used for thermal recovery or relayed to heat carrier furnaces. The water, oligomers and glycol can also be subjected to osmotic separation. In this regard, however, reference is made to sufficiently known techniques.

A lower section 44 of the drop tower 12 with preferably a larger cross section empties in a crystallization stage 45 enveloping a funnel 46, a purely basic representation of which can be gleaned from FIG. 5 on a magnified scale.

The funnel 46 of the crystallization stage or pre-crystallization stage 45 encompasses a funnel-shaped base unit 47, which can consist of metal, e.g., special steel.

A cloth-like element 50 that consists in particular of polytetrafluoroethylene and has openings with a mesh size d of d≦0.2 mm, in particular d≦0.1 mm extends along the inner wall 48 of the funnel-shaped base unit 47. The gap 52 between the base unit 47 and cloth-like element 50 is exposed to an gas, in particular air, via connecting pieces 54, 56 in order to expand the cloth-like element 50 hereinafter simply referred to as cloth in a pulsed manner, so that it moves inside the base unit 47 (dotted line) or runs quasi-equidistantly to the inner surface 48 of the base unit 47. The first “expanded” position of the cloth 50 is marked 58, and the base position is marked 60.

Pulsing the cloth 50 centrifuges back arising drops, thereby preventing adhesion on the one hand, while avoiding agglutination during a collision with another drop owing to the transmitted pulse on the other. At the same time, only a negligible deformation can arise. This swirling in crystallization stage 45 causes the drops to undergo initial crystallization to an extent where they can be relayed to a crystallization stage 62 without the drops sticking together.

The gas supplied to the crystallization stage 45, preferably in the form of air, is circulated in a cycle 64 accommodating a rotatable lid 66 that opens and closes the cycle, pulsing the gas into the gap 52 between the base unit 47 and cloth 50. In this case, the shut-off element 66 should be adjusted in such a way as to yield a pulse frequency of between 1 and 20 Hz. The maximum pressure of the gas should be 200 mbar, preferably at most 150 mbar, over atmospheric pressure. The gas itself should pass through the cloth at a maximum rate of 1-4 m/sec, preferably at a rate of between 1 and 3 m/sec. In addition, the gas should have a temperature of between 80° and 170° C. when passing through the cloth 50.

In order to set the gas to the desired temperature at the start of crystallization, the cycle 64 has a heat exchanger 68 preceded by a fan 70, which conveys gas quantities of between 1,000 m³/h and 5,000 m³/h. However, these gas quantities depend on the product throughputs of the respective system. The gas is heated up by the passage through the crystallization stage 45 and lower section 44 of the drop tower 12. Cooling to the desired temperature also takes place by eliminating a portion of the gas via a line 72 and relaying it to a cleaning stage 74 that encompasses a glycol cycle 76. This removes any oligomers present in the gas. At the same time, the gas is cooled, as a result of which the desired temperature of the gas stream passing through the cloth 50 can be set via the gas returned to the cycle 64 via line 78. In addition, the cycle 64 has branching from it a line 80 connected with a gas distribution device 82 arranged at the lower edge of the lower section 44 of the drop tower 12. The distance to the upper edge of the section 44 is marked A. The annular nozzle 20 for the spray mist is located above the distance A.

As particularly evident from the basic representation according to FIG. 1 and a comparison with FIGS. 3 and 4, the air cycle 64 incorporating the crystallization stage 45 is situated under the spray mist cycle 30.

FIG. 1 shows the drop tower 12, in which a spray mist whose drops have a diameter far less than 0.1 mm is emitted counter to the falling direction of the drops 22. This spray mist is sprayed between the particles dripped by the nozzle 10, wherein the spray mist drops evaporate when contacting the drops 22. The polymer drops 22 cool at the same time.

In this case, the sprayed mist is adjusted in terms of temperature and mass flow so that the drops fall at an ambient temperature of about 170° C. toward the crystallization stage 45, as a result of which an optimal crystallization temperature is established. This temperature is measured under the annular nozzle, e.g., at a distance of 100 cm to 1000 cm, for adjustment purposes.

In addition, attention must be drawn to the following. The inventive instruction was previously explained based on a cloth made to oscillate to generate the pre-crystallization stage 45. However, this does not place a limit on the invention. The pre-crystallization stage can also comprise a fluid-bed chamber or funnel-shaped, intrinsically stiff element, e.g., in particular a sheet element, having through holes, so that the drops 22 can be swirled inside the resultant funnel or just over it, preventing the drops from sticking to each other or adhering to walls. In this case, the holes in the fluid-bed chamber or intrinsically stiff element are designed in such a way as to generate a tangential gas stream component, meaning that gas flows along the inner surface of the, e.g., funnel-shaped section, wherein a turbulence strong enough to force the drops toward the middle of the funnel or toward its outlet hole arises at the same time. The funnel-shaped, intrinsically stiff element in particular involves one known as Conidurblech® or having a corresponding, equivalently acting structure.

Crystallization stage 45 is followed by crystallization stage 62, the inlet hole of which corresponds to the outlet hole of the funnel 46 or its base unit 47. Crystallization stage 62 is situated in another cycle 84, through which a portion of the crystallized spheres removed from the crystallization stage 62 is returned to the area of the funnel 46. The advantage here is that the spheres removed from crystallization stage 62 to be supplied to post-condensation stage 18 are crystallized to an extent that prevents agglutination, in particular in the funnel 46. In particular, roughly 10-50% of the spheres removed via a line 86 of the crystallization device 62 are returned to the funnel 46 via cycle 84.

Line 86 leads to a transfer channel 88 that can be sealed at the inlet and outlet by a shut-off element 90, 92 preferably designed as an iris diaphragm or cell edge transfer channel. This ensures that the spheres will not be destroyed. Once the transfer channel 88 has been sufficiently filled with crystallized spheres, the shut-off devices 90, 92 are closed, and a pressure corresponding to the ensuing condensation stage 18 is built up in the transfer channel 88. The condensation stage 18 normally has a pressure of 0.5 mbar (abs.). After the required vacuum has been reached, the shut-off element 92 is opened, so that the spheres can be relayed to the post-condensation stage in the form of a slowly rotating screw 94, without any danger of oxygen influx. The desired post-condensation takes place in the post-polycondensation stage 18 under a vacuum and without any oxygen, wherein adding a chain lengthener to the molten prepolymer (line 16) reduces the process to 8-12 hours, as compared to 15-25 hours without a chain lengthener. As mentioned, the post-polycondensation stage 18 encompasses the very slowly rotating screw 94, and is peripherally enveloped by a heating jacket 96. After polycondensation, the spheres are routed to another transfer channel 98, whose structure matches that of transfer channel 88, and can hence have a shut-off element 100, 102 situated upstream or downstream in the form of an iris diaphragm.

The reaction products contained in the gases discharged from the transfer channel 88 via a line 104 and from the line 106 directly connected with the post-polycondensation stage 18, e.g., ethylene glycol or butane diol, water, oligomers or acetaldehyde or tetrahydrofuran, are separated in the usual manner in a glycol cycle 108 or in a vacuum unit 110, and then prepared for reutilization. In this regard, however, reference is made to sufficiently known techniques.

The instruction according to the invention cumulatively or alternatively differs from the known methods and devices for manufacturing in particular PET and/or PTB spheres in that:

When drops are to be pre- or initially crystallized inside a drop tower, air or gas is replaced by a spray mist passed countercurrently through the drop tower at a flow rate that prevents swirling;
The particles solidify and product temperature is precisely set after a relatively short drop distance;
Pre-crystallization takes place in a section of the arrangement designed as a funnel downstream from the drop distance where the drops are swirled in such a way as to prevent adhesion to a wall or an agglomeration of the drops themselves;
Immediately before dripping the molten prepolymer or polymer, a chain lengthener is added, which basically only exerts its effect in a post-polycondensation stage.

Reference List

| | | | |
|---|---|---|---|
| 10 | Nozzle plate | 60 | Base position |
| 12 | Drop tower | 61 | Crystallization stage |
| 14 | Line | 64 | Cycle |
| 16 | Line | 66 | Expanding lid |
| 18 | Postcondensation | 68 | Heat exchanger |
| 20 | Nozzle array | 70 | Fan |
| 22 | Polymer drops | 72 | Line |
| 24 | Arrow | 74 | Cleaning stage |
| 26 | Gas suction device | 76 | Glycol cycle |
| 28 | Inner wall | 78 | Line |
| 30 | Cycle | 80 | Line |
| 32 | Fan | 82 | Gas distribution |
| 34 | Condenser | | device |
| 36 | Connecting piece | 84 | Cycle |
| 38 | Pump | 86 | Line |
| 40 | Line | 88 | Transfer channel |
| 42 | Line | 90 | Shut-off element |
| 44 | Lower section | 92 | Shut-off element |
| 45 | Crystallization stage | 94 | Screw |
| 46 | Funnel | 96 | Heating jacket |
| 47 | Base unit | 98 | Transfer channel |
| 48 | Inner wall | 100 | Shut-off element |
| 50 | Cloth-like element | 102 | Shut-off element |
| 52 | Gap | 104 | Line |
| 53 | Connecting piece | 106 | Line |
| 56 | Connecting piece | 108 | Glycol cycle |
| 68 | Expanded position | 110 | Vacuum unit |
| | | A | Distance |

1. A method for manufacturing spherical particles out of plastic, in particular a prepolymer- or polymer melt of a polycondensate, e.g., PET, PBT, PEN, PA or PC, wherein the melt is dripped into droplets by means of an dripping nozzle with numerous melt outlet holes, and the droplets are solidified into particles after falling at least part of a drop distance, characterized in that, at the end of the drop distance, the particles make their way into a receiving area in which at least some of the particles are swirled in such a way as to generate turbulences to move the particles toward the middle of the area and/or area outlet hole.

2. The method according to claim 1, characterized in that the particles in the receiving area are swirled by vibrating at least part of the receiving area.

3. The method according to claim 1 or 2, characterized in that the particles in the receiving area are swirled by blowing a gas through numerous gassing holes.

4. The method according to one of the preceding claims, characterized in that the particles in the receiving area are swirled by means of a cloth-like element interspersed with gas and made to oscillate and/or routed to an area with an intrinsically stiff element at the end of the drop distance that is pressurized with gas in such a way as to produce turbulences for moving the drops toward the middle of the area and/or area outlet opening.

5. The method according to one of the preceding claims, characterized in that the swirled particles form a fluid bed.

6. The method according to claim 5, characterized in that the particles are relayed to the fluid bed via a fluid bed inlet area from the drop distance, and therein moved to a fluid bed outlet area that accommodates the area outlet hole.

7. The method according to claim 6, characterized in that the particles are deflected to the fluid bed inlet area at the end of the drop distance.

8. The method according to one of the preceding claims, characterized in that the particles in the drop distance are exposed to a fluid, in particular a liquid.

9. The method for manufacturing spherical particles out of plastic, in particular a prepolymer- or polymer melt of a polycondensate, e.g., PET, PDT, PEN, PA or PC, in particular according to one of the preceding claims, wherein the melt is dripped into droplets by means of a dripping nozzle with numerous melt outlet holes, and the droplets are solidified into particles after falling at least part of a drop distance, characterized in that the particles in the drop distance are exposed to a liquid.

10. The method according to claim 9, characterized in that the particles at the end of the drop distance get into a receiving area in which at least some of the particles are swirled in such a way as to generate turbulences to move the particles toward the middle of the area and/or area outlet hole.

11. The method according to claim 9 or 10, characterized in that the particles in the receiving area are swirled by vibrating at least part of the receiving area.

12. The method according to one of claims 9 to 11, characterized in that the particles in the receiving area are swirled by blowing in a gas through numerous gassing holes.

13. The method according to one of claims 9 to 12, characterized in that the particles in the receiving area are swirled by means of a cloth-like element interspersed with gas and made to oscillate and/or routed to an area with an intrinsically stiff element at the end of the drop distance that is pressurized with gas in such a way as to produce turbulences for moving the particles toward the middle of the area and/or area outlet opening.

14. The method according to one of claims 9 to 13, characterized in that the swirled particles form a fluid bed.

15. The method according to claim 14, characterized in that the particles are relayed to the fluid bed via a fluid bed inlet area from the drop distance, and therein moved to a fluid bed outlet area that accommodates the outlet hole.

16. The method according to claim 15, characterized in that the particles are deflected to the fluid bed inlet area at the end of the drop distance.

17. The method according to one of the preceding claims, characterized in that the evaporation point of the liquid lies under the melting point of the particles.

18. The method according to at least one of the preceding claims, characterized in that the liquid has water and/or ethylene glycol.

19. The method according to at least one of the preceding claims, characterized in that the liquid is atomized in the form of fine droplets, so that the drops in the drop distance dripped into droplets with the dripping nozzle are pressurized with a spray mist.

20. The method according to claim 19, characterized in that the spray mist is set in such a way that its drop size corresponds to about ⅓ to 1/20 of the drop size of the dripped melt.

21. The method according to one of claims 19 to 20, characterized in that the liquid is supplied in a carrier gas.

22. The method according to claim 21, characterized in that the carrier gas has at least one of the gases air, nitrogen, carbon dioxide, argon, water vapor or ethylene glycol vapor.

23. The method according to one of the preceding claims, characterized in that the drops are at least initially crystallized after falling through at least a portion of the drop distance.

24. The method according to one of the preceding claims, characterized in that the drops are only cooled to a point where their temperature remains over the glass transition temperature T_{g} of the plastic.

25. The method according to one of the preceding claims, characterized in that the thermal energy of the process gases present in the drop distance, e.g., air, nitrogen, carbon dioxide, argon, water vapor or ethylene glycol vapor, is recovered.

26. The method according to one of the preceding claims, characterized in that the spherical or sphere-like particles are relayed to a crystallization stage after leaving the receiving area.

27. The method according to one of the preceding claims, characterized in that, after going through the one or more crystallization steps, the spherical particles are supplied to the one or more crystallization stages of a post-condensation stage for solid-state polycondensation.

28. The method according to one of the preceding claims, characterized in that the drops are emitted from the dripping nozzle in a cross-shaped outer area of the dripping nozzle.

29. The method according to one of the preceding claims, characterized in that at least some of the drops emitted from the dripping nozzle have a horizontal motion component.

30. The method according to one of the preceding claims, characterized in that the receiving area is pressurized with gas, such as air, in a pulsed fashion.

31. The method according to one of the preceding claims, characterized in that the receiving area is funnel-shaped in design, and has gas-permeated openings on the drip side that run in such a way as to move or swirl the drops tangentially along the inner surface of the funnel-shaped area.

32. The method according to one of the preceding claims, characterized in that the receiving area is pressurized using a gas with a sinusoidal pressure characteristic.

33. The method according to one of the preceding claims, characterized in that the pulsed gas pressurizes the receiving area at a frequency f of preferably 1 Hz≦f≦30 Hz, in particular 1 Hz≦f≦10 Hz.

34. The method according to one of the preceding claims, characterized in that the gas permeates the receiving area at a maximum velocity v of v≦4 m/sec, in particular v≦3 m/sec, preferably v≦1 m/sec.

35. The method according to one of the preceding claims, characterized in that the gas pressurizes the receiving area with a pressure p of 0 mbar≦p≦200 mbar, in particular 0 mbar≦p≦150 mbar over atmospheric pressure.

36. The method according to one of the preceding claims, characterized in that the receiving area uses openings with a mesh size of d≦80%, in particular d≦30% of the average particle diameter.

37. The method according to one of the preceding claims, characterized in that a portion of the particles crystallized into spheres or at least initially crystallized is removed from the crystallization device and returned to the drops falling through the drop distance above the receiving area.

38. The method according to one of the preceding claims, characterized in that about 10 to 50% of the spheres removed from the crystallization device are returned to the receiving area.

39. The method according to one of the preceding claims, characterized in that a chain lengthener that accelerates postcondensation is added to the melt immediately prior to dripping.

40. The method according to one of the preceding claims, characterized in that the share of chain lengthener in the melt to be dripped measures <0.5% w/w.

41. The method according to one of the preceding claims, characterized in that the chain lengthener is preferably added to the melt in an amount in which it becomes active after a time t₁ of t₁≦10 min, in particular 1 min≦t₁≦10 min.

42. The method according to one of the preceding claims, characterized in that chain lengtheners include those based on polyol, dianhydride of a tetracarbonic acid, pentaerythrite or oxazolines.

43. Method according to one of the preceding claims, characterized in that the drops are exposed over at least part of the drop distance to a countercurrent, which is preferably laminar.

44. The method according to one of the preceding claims, characterized in that the drops are exposed over at least part of the drop distance to a cocurrent, which is preferably laminar.

45. The method according to one of the preceding claims, characterized in that the countercurrent is withdrawn at a velocity of less than 0.2 m/sec, preferably less than 0.1 m/sec.

46. The method according to one of the preceding claims, characterized in that the cocurrent is withdrawn at a velocity of less than 1 m/sec, preferably less than 0.5 m/sec.

47. The method according to one of the preceding claims, characterized in that the gas permeating the receiving area flows through a first cycle, wherein a portion of the gas is routed to a cleaning station, in which the gas is cleaned and cooled, after which it is returned to the cycle once again.

48. The method according to one of the preceding claims, characterized in that the gas is here preferably guided in the cleaning station countercurrently or cocurrently to a glycol cycle.

49. A device for manufacturing spherical particles out of plastic, in particular a prepolymer- or polymer melt of a polycondensate, e.g., PET, PBT, PEN, PA or PC, with a nozzle array that drips the plastic melt along with a downstream drop distance in a drop tower, characterized in that the drop distance passes over into a receiving area in which at least some of the particles can be swirled in such a way as to generate turbulences to move the particles toward the middle of the area and/or area outlet hole.

50. The device for manufacturing spherical particles out of plastic, in particular a prepolymer- or polymer melt of a polycondensate, e.g., PET, PBT, PEN, PA or PC, with a nozzle array that drips the plastic melt along with a downstream drop distance in a drop tower, characterized in that a device for exposing the particles to a liquid is allocated to the drop tower.

51. The device according to one of claims 49 or 50, characterized in that the receiving area is designed as a funnel.

52. The device according to one of claims 49 to 51, characterized in that at least part of the receiving area can be vibrated by vibration means.

53. The device according to one of claims 49 to 52, characterized in that the receiving area can be exposed to a gas via numerous gassing holes.

54. The device according to one of claims 49 to 52, characterized in that the drop distance passes over into a funnel-shaped receiver (45) peripherally bordered by a pulsating, cloth-like element (50) and/or intrinsically stiff element with holes.

55. The device according to one of claims 49 to 54, characterized in that the receiving area has an inlet area and outlet area.

56. The device according to claim 55, characterized in that the end of the drop distance or the lower end of the drop tower has deflection means that can guide the particles to the inlet area.

57. The device according to claim 55, characterized in that the melt outlet holes of the nozzle array (10) can be arranged in an area of the nozzle array (10) that is situated vertically above the inlet area and has essentially the same layout as the inlet area.

58. The device according to claim 55, characterized in that at least some of the melt outlet holes of the nozzle array (10) are angled relative to the vertical.

59. The device according to one of claims 49 or 58, characterized in that the drop tower incorporates atomizing means that can be used to introduce an atomized liquid into the drop distance.

60. The device according to one of claims 49 to 59, characterized in that it has means for recovering thermal energy, which can be used to recover the process heat contained in the process gases present in the drop tower.

61. The device according to one of claims 49 to 60, characterized in that a crystallization stage (62) follows the receiving area.

62. The device according to one of claims 49 to 61, characterized in that the one or more crystallization stages has a downstream post-condensation stage (18) for solid-state polycondensation.

63. The device according to one of claims 49 to 62, characterized in that the receiving area can be exposed to a pulsating gas, such as air.

64. The device according to one of claims 49 to 63, characterized in that the receiving area is a cloth-like element (50) secured to a funnel (46), e.g., a metal or special steel funnel, and can be spaced apart relative to its inner surface (48) in such a way that a line (54, 56) incorporating a shut-off element (66) that releases or blocks said line empties into the gap (52) between the cloth-like element and funnel.

65. The device according to one of claims 49 to 63, characterized in that receiving area is an intrinsically stiff element, which is enveloped at a distance by a funnel element in such a way that a line (54, 56) incorporating a shut-off element (66) that releases or blocks said line empties into the gap (52) between the intrinsically stiff element and the funnel element.

66. The device according to one of claims 49 to 63, characterized in that the receiving area is a fluid-bed chamber.

67. The device according to claim 66, characterized in that the fluid-bed chamber is connected by numerous gassing holes with a gas inlet chamber, into which empties a line incorporating a shut-off element that releases of blocks said line.

68. The device according to one of claims 49 to 67, characterized in that the gas can be relayed to the gap (52) pulsating at a frequency f, wherein the frequency f in particular measures 1 Hz≦f≦30 Hz, preferably 1 Hz≦f≦10 Hz.

69. The device according to one of claims 49 to 68, characterized in that the holes of the receiving area are designed in such a way that the gas penetrating them flows along the inner surface of the receiving area, in particular in a turbulent manner.

70. The device according to one of claims 49 to 69, characterized in that the holes are designed in such a way that the gas passing through them flows tangentially to the inner surface of the intrinsically stiff element.

71. The device according to one of claims 49 to 70, characterized in that the gas can be supplied to the gap (52) of the arrangement with a sinusoidal pressure progression.

72. The device according to one of claims 49 to 71, characterized in that the receiving area is anti-adhesive, and consists in particular of polytetrafluoroethylene.

73. The device according to one of claims 49 to 72, characterized in that the receiving area preferably has holes with a mesh size d of d≦0.6 mm, in particular d≦0.3 mm.

74. The device according to one of claims 49 to 73, characterized in that it has a first cycle (64) through which the gas penetrating the receiving area flows, and from which a branch running along the drop distance exits the drop distance at distance A, wherein a ring element (20) that emits a spray mist, envelops the drop distance and is equipped with spray nozzles is located above distance A.

75. The device according to claim 74, characterized in that the ring element (20) with spray nozzles is preferably situated in a second cycle (30), which itself is routed out of the drop distance below the nozzle array (10) that drips the melt.

76. The device according to one of claims 75 or 75, characterized in that a portion of the gas carried in the first cycle (64) is routed to a cleaning station (74) that encompasses a glycol cycle.

77. The device according to one of claims 49 to 76, characterized in that the crystallization device (62) preferably has an inlet hole, which is simultaneously the outlet hole of the funnel (46).

78. The device according to one of claims 49 to 77, characterized in that the crystallization device (62) is placed in another cycle (84), through which some of the spheres crystallized in the crystallization device above the funnel (46) or intrinsically stiff element can be returned to the drop distance.

79. The device according to one of claims 62 to 78, characterized in that the post-condensation stage (18) preferably has an upstream and/or downstream transfer channel (88, 98), which can be sealed at the inlet and/or outlet by a shut-off element preferably (90, 92, 100, 102) designed as an iris diaphragm.

80. The device according to one of claims 49 to 79, characterized in that the nozzle array (10) designed in particular as a vibratable nozzle plate is connected to a line (14) that supplies the melt, in which another line (16) connected with a container for a plastic chain lengthener empties immediately before the nozzle element or into the nozzle element itself.
